(19) United States
(12) Patent Application Publication
(10) Pub. No.: US 2008/0037243 A1
(43) Pub. Date: Feb. 14, 2008

(54) RECHARGEABLE LIGHTING SYSTEM

(75) Inventors: Justin Miles Discoe, Fort Collins, CO (US); Christopher J. Clemmer, Sparta, NJ (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Holiday Creations, Inc., Littleton, CO (US)

(21) Appl. No.: 11/837,912

(22) Filed: Aug. 13, 2007

Related U.S. Application Data
(60) Provisional application No. 60/822,167, filed on Aug. 11, 2006.

(51) Int. Cl. F21L 4/00

(52) U.S. Cl. 362/183; 362/193

(57) ABSTRACT

A lighting system employing a wind energy system to collect and convert wind energy to electrical energy for recharging an energy storage source. The wind energy system may be a vertical or horizontal wind turbine. A solar energy system may also be employed to collect and convert solar energy to electrical energy to recharge the energy storage source. The energy storage source may provide electrical power to one or more lighting elements associated with the lighting system. The lighting elements may include light emitting diodes, fluorescent lights, cold cathode ray tubes, or other low power lighting sources. The lighting system may further include a housing to store or support one or more components of the lighting system. The housing may be supported by a post. An anchor member may be joined to the post for attaching the lighting system to the ground or a structure.

### CROSS-REFERENCE TO RELATED APPLICATIONS

This application claims the benefit under 35 U.S.C. § 119 (e) of U.S. Provisional Application No. 60/822,167, entitled “Rechargeable Lighting System” and filed Aug. 11, 2006, which is hereby incorporated in its entirety by reference herein.

### FIELD OF THE INVENTION

The present invention relates to outdoor lighting systems, and in particular, to lighting systems that convert wind energy to electrical energy to supply electricity to a rechargeable lighting power source.

### BACKGROUND

Outdoor lighting systems have been around for many years. However, low-cost, low power lighting systems utilizing batteries recharged using solar energy are relatively new. There are drawbacks, however, associated with these conventional systems. For example, short periods of illumination may result when the charging performance of the solar system is limited during low light conditions, such as during winter months or on cloudy days.

### SUMMARY

One aspect of the present invention may take the form of a lighting system including a housing, a rechargeable electrical power source, a wind energy system, and at least one lighting element. The wind energy system may be positioned proximate to the housing. The wind energy system collects wind energy and converts the collected wind energy into electrical energy. At least a portion of the wind energy collected and converted into electrical energy may be used to recharge the rechargeable electrical power source. The lighting system may be electrically coupled to the rechargeable power source.

Another aspect of the present invention may take the form of a lighting system including a means for collecting wind energy, a means for converting wind energy into electrical energy, a means for storing electrical energy, a means for adjusting the height of the lighting system, and a lighting element. The wind energy collecting means may be operably associated with the wind energy converting means. The electrical energy storing means may be operably coupled to the wind energy converting means. The height adjusting means may be operably associated with the electrical energy storing means. The lighting element may be operably connected to the electrical energy storing means. At least a portion of the electrical energy converted by the wind energy converting means may be used to recharge the electrical energy storing means.

### BRIEF DESCRIPTION OF THE DRAWINGS

FIG. 1 depicts an exploded perspective view of a first embodiment of a rechargeable lighting system.

FIG. 2 depicts an exploded perspective view of a light assembly for the rechargeable lighting system shown in FIG. 1.

FIG. 3 depicts a schematic diagram of the lighting system of FIG. 1, showing one possible operational relationship between various components of the lighting system.

FIG. 4 depicts a perspective view of a portion of the rechargeable lighting system shown in FIG. 1, showing one arrangement for blades that spin about a longitudinal axis in the presence of wind.

FIG. 5 depicts a perspective view of a portion of the rechargeable lighting system shown in FIG. 1, showing portions of lighting attachments for connection to the housing of the rechargeable lighting system.

FIG. 6 depicts a perspective view of the rechargeable lighting system shown in FIG. 1, showing one of the lighting attachments of FIG. 5 including one or more lighting elements.

FIG. 7 depicts a perspective view of another versions of the lighting system shown in FIG. 1, showing a bracket for joining the lighting system to another object.

FIG. 8 depicts a perspective view of second embodiment of a rechargeable lighting system.

FIG. 9 depicts perspective views of a variety of garden styles for rechargeable lighting systems.

### DETAILED DESCRIPTION

Aspects of the present invention may take the form of a lighting system including one or more energy collection systems for collecting and providing electrical energy to recharge an electrical power source. The electrical power source may store and provide power for one or more lighting attachments connected to the lighting system. A first energy collection system may take the form of a wind energy system that collects wind energy and converts the wind energy into electrical energy. A second energy collection system may take the form of a solar energy system that collects and converts solar energy into electrical energy. The wind energy system and/or the solar energy system may be in electrical communication with the one or more electrical energy sources that store and provide power to one or more lighting elements of the lighting system.

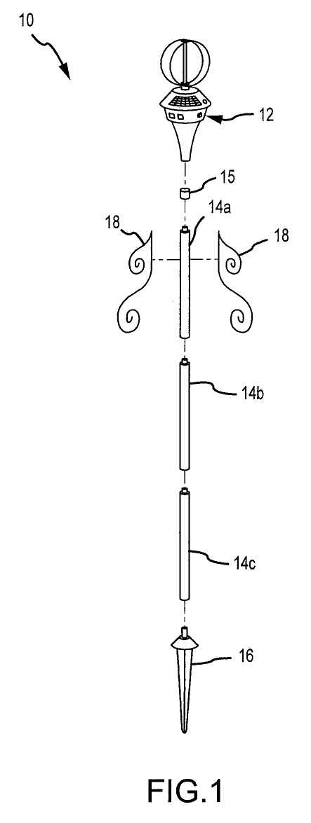

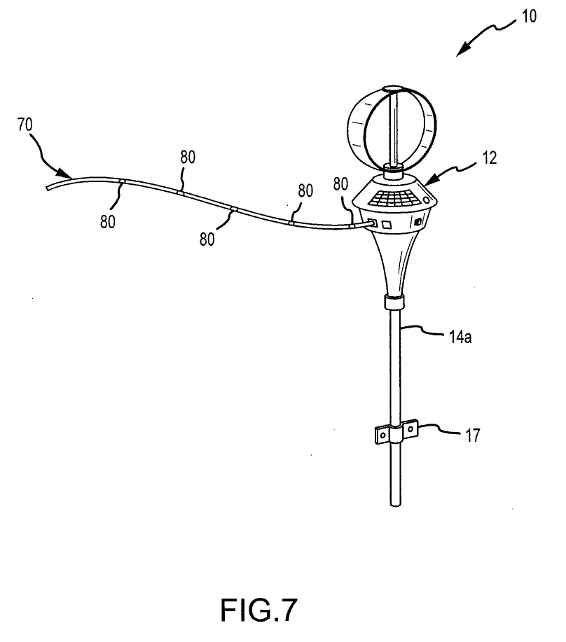

FIG. 1 depicts a first embodiment of a lighting system 10. The lighting system 10 may include a light assembly 12 supported by a tubular, square, triangular, solid or other suitably shaped post or other support member, which may be formed using one or more post segments 14a-c. The light assembly 12 may be attached to the post using a coupling member 15, such as a threaded coupling nut or the like. An anchor member 16 may be fixedly or removably joined to the post. The anchor member 16 may be a ground spike (see FIG. 1) or other anchoring system (e.g., a base plate with anchor bolts) for securing the light assembly to the ground in a lawn, flowerbed, or along a walkway, and so on, or may take the form of a bracket member or the like (see FIG. 7) for securing the light assembly 12 to a structure, such as a fence, deck, house, building, and so on.

The post segments 14a-c may be used to adjust the height of the light assembly 12 to optimize the collection of wind and/or solar energy, to position the light assembly 12 at a desired elevation for aesthetic or other reasons, or both. For example, more post segments of a given length may be joined together to increase the height of the post, and fewer post segments may be joined together to decrease the height of the post. The post segments 14a-c may be joined to each other using threads, snaps, press fits, welds, adhesives, any other suitable connection means, or any combination thereof.

In some embodiments, the post may take the form of a telescoping post to adjust the height of the light assembly 12. Such a telescoping post may be formed from two or more post segments that nest within each other. The telescoping post may further include a spring or otherwise biased button or other detent system for selectively securing nested post segments relative to each other at one or more height adjustment positions. One or more holes may be defined in one or more of the nested post segments for receiving the spring or otherwise biased button. The light assembly 12 may also be directly attached, fixedly or removably, to the anchor member 16. Decorative brackets 18 may be fixedly or removably joined to, and/or integrally formed with, one or more of the post segments 14a-c.

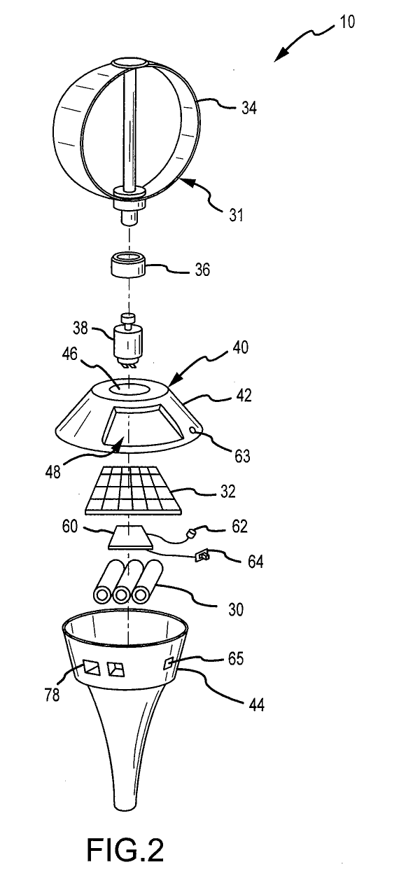

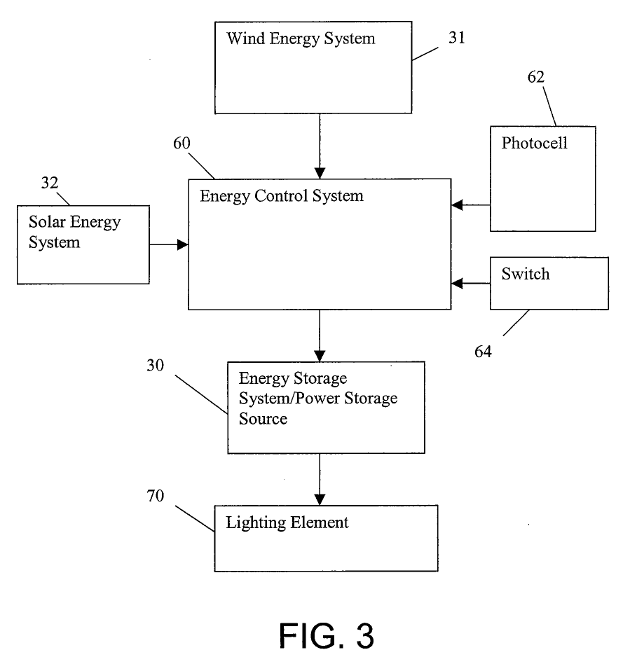

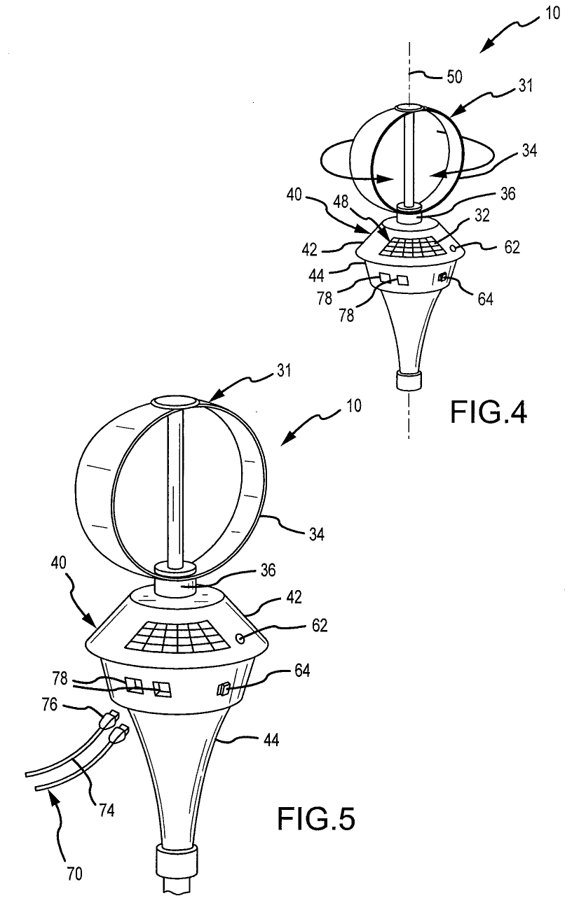

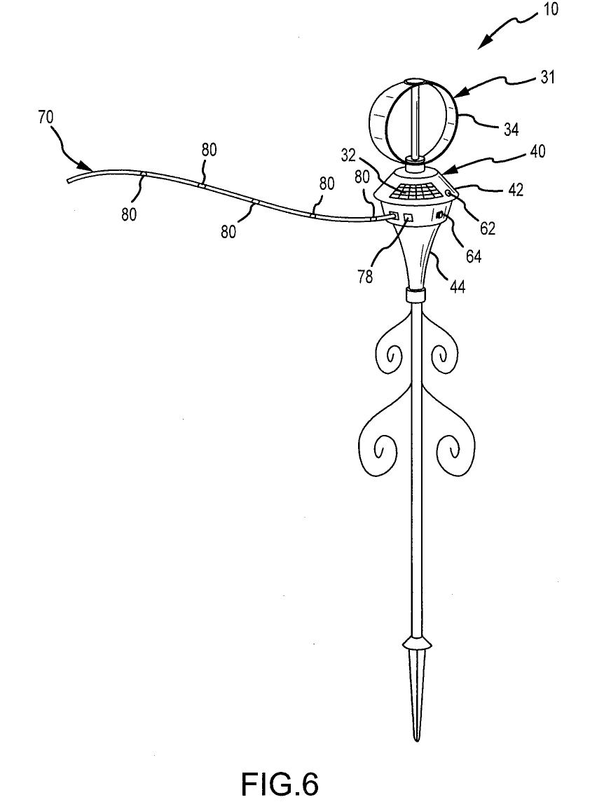

FIG. 2 depicts an exploded perspective view of a portion of the lighting system 10, and FIG. 3 depicts a schematic view showing one possible interrelationship between various components of the lighting system 10. FIGS. 4 and 5 depict perspective views of a portion of the lighting system 10. FIG. 6 depicts a perspective view of the lighting system 10, showing one possible light element 70 for the lighting system 10.

With reference to FIGS. 2-6, the light assembly 12 may include a power storage source 30, a wind energy system 31, a solar energy system 32, a housing 40, an energy control system 60, and one or more lighting elements 70. The wind energy system 31 and the solar energy system 32 may each be operably connected with the power storage source 30 to provide electrical energy to the power storage source 30. The housing 40 may support the wind energy system 31 and may provide a space, surface or other area for containing or attaching at least portions of the power storage source 30, the solar energy system 32, the energy control system 60, and/or the lighting elements 70. The energy control system 60 may be operably coupled to the power storage source 30, the wind energy system 31, the solar energy system 32, and the lighting elements 70 to control the various interactions between these components. The power storage source 30 may be operably coupled to one or more lighting elements 70 to provide electrical power for the lighting elements 70.

The power storage source 30 may take the form of any suitable rechargeable power storage source, including rechargeable batteries such as nickel cadmium, nickel metal hydride, and lithium-ion as well as electrical capacitors. For example, the power storage source 30 may take the form of one or more rechargeable batteries, such as AA rechargeable batteries. Three rechargeable AA batteries are shown in FIG. 2. However, other embodiments may use more or less rechargeable batteries of lesser or greater capacity.

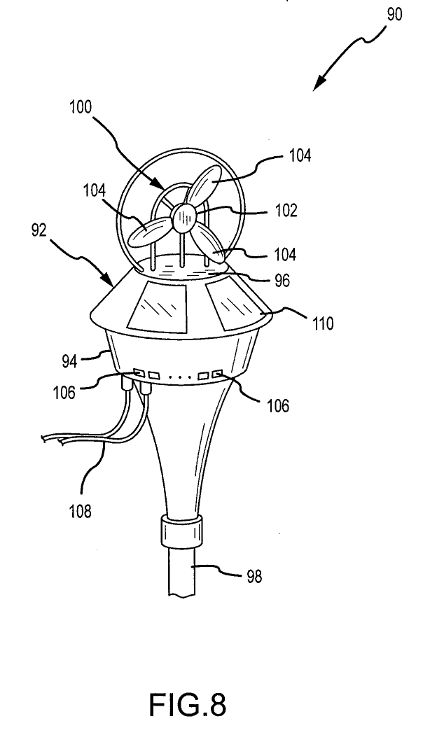

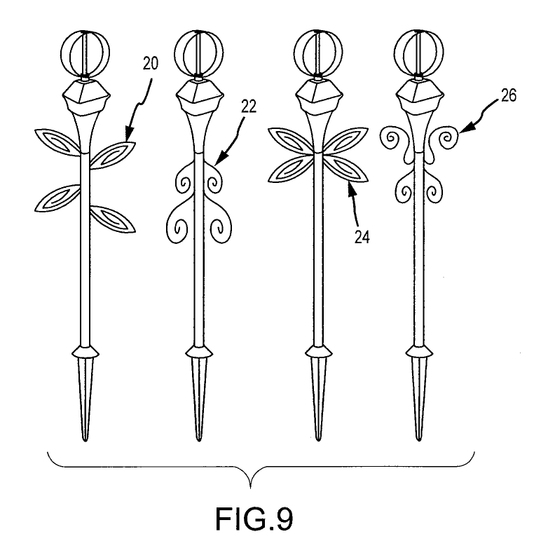

The wind energy system 31 may take the form of a wind turbine. The wind turbine may include a blade arrangement 34 joined to a generator 38 via a hub 36. The blade arrangement 34 captures wind energy, and the generator 38 converts the wind energy into electrical energy. The blades 34 capture wind energy by spinning about a vertical axis 50 as shown, for example, in FIGS. 4-5, a horizontal axis as shown for example, in FIG. 8, or about some other oriented axis in the presence of wind. As the blades 34 spin, the blade motion is transferred to the generator 38 through the hub 36 causing the generator 38 to produce electrical energy. The generator 38 provides a trickle charge to charge the one or more the energy storage sources 30 electrically coupled to the generator 38 as long as there is sufficient wind to turn the blades 34.

The wind turbine configuration shown in FIGS. 4-6 and other figures may be referred to as a vertical axis wind turbine, and the configuration shown in FIG. 8 may be referred to as a horizontal axis wind turbine. With respect to the vertical wind turbine, the blade arrangement 34 may resemble an eggbeater blade as shown in FIGS. 4-6. However, the blade arrangement 34 for a vertical type of wind turbine may take other forms, including, but not limited to, taking the form of wind sails, vertical blades, scoop drag-type devices, other known blade arrangements and configurations for vertical wind turbines, or any combination thereof.

With continued reference to FIGS. 2-5, the solar energy system 32, if used, may take the form of a solar panel. Although one solar panel is depicted in FIGS. 2-5, more or less solar panels may be used. In other embodiments, one or more photovoltaic solar cells may be used to collect the solar energy for conversion to electrical energy for using in the lighting system 10.

A lighting system that employs both a wind and a solar energy system for providing energy to the energy storage source 30 can potentially keep lights illuminated longer than a system employing only wind energy or solar energy to provide electricity to the lighting elements 70, and can also potentially provide better charging performance in low light conditions, such as during winter months, cloudy conditions, and so on. For example, solar energy may be captured during daylight hours to recharge the energy storage source 30, and wind energy may be captured whenever the wind is blowing to also recharge the energy storage source 30. Further, the wind energy system 31 will work, provided there is some wind, irrespective of lighting conditions that can drastically reduce the performance of a lighting system relying only upon solar power to provide electrical energy. The wind blades 34 of the wind energy system 31 may also add a decorative aspect to the lighting system 10 and may potentially startle birds and rodents away from crops and flowers.

The housing 40 may be formed from a top housing portion 42 and bottom housing portion 44, which may be removably or fixedly joined together. More or less housing portions may be used to form the housing 40. The top and bottom housing portions 42, 44, or any other number of housing portions, may be joined together using threaded or snap connections, heat or sonic welds, adhesives, any other suitable connection method, or any combination thereof. The size and shape of the housing 40 may be altered to hold more or fewer energy storage sources 30 or other lighting system components, and/or to hold energy storage sources 30 or other lighting system components having different shapes. Removably joining the top and bottom housing portions 42, 44 may increase the ease for maintaining, repairing, or replacing components contained with the housing 40, and or may allow changing the shape or style of the housing 40 through use of interchangeable or componentized housing portions.

A chamber may be defined by the housing 40 for containing the generator 38. The top housing portion 42 may have a circular or any other suitably shaped hub opening 46 for receiving the hub 36. The top housing portion 42 may be dome shaped, or any other desired shape, and may be operably connected to the bottom housing portion 44 to form a water and/or weather resistant housing 40. The top housing portion 42 may include a solar opening 48, or openings, for providing solar light access to one or more solar panels or cells mounted on or within the housing 40. Although the solar opening 48 for the solar panel is shown as located in the top housing portion 42, such openings may be formed in the bottom housing portion 44, or in both the top and bottom housing portions 42, 44. Any or all of the solar openings 48 may be covered by a transparent panel configured to form a water resistant seal with the housing 40. The bottom housing portion 42 may be funnel-shaped, or any other desired shaped, and may be sized to receive the energy storage source 30 and the energy control system 60.

The energy control system 60, which may be defined on a printed circuit board, routes electrical energy from the wind and solar energy systems 31, 32 to the one or more energy storage sources 30. The energy control system 60 may control the charging operation of the generator 38, control the charging operation of the solar system 32 monitor the charge status of the energy storage sources 30, control when lighting elements 70 are illuminated, and control other power management functions. The energy control system 60 may include a voltage converter to change the voltage level provided by the energy storage source 60 to a higher or lower voltage level suitable for powering the lights 80 of the lighting elements 70 coupled to the energy control system 60.

A photocell 62 and a switch 64 may also be connected to the energy control system 60. The photocell 62 senses the ambient light level and may be used to turn the lights 80 of the lighting elements 70 connected to the housing 40 on and off or to control the intensity of the light emitted by the lights 80 depending upon the amount of light hitting the photocell 62. The switch 64 may be used to override the photocell 62 and turn the lights 80 on or off. The switch 64 may be movable to two or more positions to control the lights 80. The switch 64 may be a toggle type switch as shown in FIGS. 4-6, a rotary type switch, or any other type of switch. The switch 64 may be configured to function as a dimmer switch, a timed switch, a wireless controlled switch, or any other known switch used with a lighting element. Access to the switch may be provided by a switch opening 65 in the bottom housing portion 44 as shown in FIGS. 4-6, through a switch opening in the top housing portion 42, or a switch opening defined in the top and bottom housing portions 42, 44. A photocell hole 63 in the top housing portion 42 as shown in FIGS. 4-6, the bottom housing portion 44, or both, may provide an opening for ambient light to reach the photocell 62.

Lighting elements 70 for the lighting system 10 may include one or more types of lights, including light emitting diodes (LEDs), fluorescent lights, cold cathode ray tubes and other low power lighting sources. As depicted, for example, in FIG. 5, the lighting elements 70 may be connected to the housing 40 via conductors 74 including plugs 76 adapted to mate with connectors 78 joined, fixedly or removably, to the housing 40. Connector holes may be defined in the housing 40 to provide access to the connectors 78. Each lighting element 70 may include one or more lights 80 as depicted, for example, in FIG. 6. In some embodiments, at least some of the lighting elements 70 may be mounted on or within the housing 40.

FIG. 8 illustrates a second embodiment of a lighting system 90. The lighting system 90 is similar to the lighting system 10 described above and depicted in FIGS. 1-6 with the primary difference being the wind turbine is a horizontal axis wind turbine rather than a vertical axis wind turbine. The horizontal wind turbine 100 may include propellers 104, as shown in FIG. 8, or other varieties of horizontal wind turbine blades for collecting wind energy. A DC or other electrical generator 102 may coupled to the propellers 104. The generator 102 may include charging wires in electrical communication with charging electronics, such as the energy control system, housed within the housing 92.

The horizontal wind turbine 100 may be supported in a fixed orientation relative to the housing 92, or may be supported on a post or other member rotatably mounted to the housing 92. Rotatably mounting the horizontal wind turbine 100 would allow it to self-orient to face the direction of the wind, and hence optimize energy generation to charge one or more energy storage sources providing electrical power to the lighting elements 106. The lighting elements 106, such as LEDs, light bulbs, fluorescent lights, cold cathode ray tubes, and so on, may be positioned on or within the housing 92 as shown in FIG. 7, attached to the housing 92 as shown, for example, in the first embodiment, or otherwise electrically coupled with the energy storage source 90. As with the first embodiment, illumination of the LEDs and/or types of lighting sources may be controlled automatically with a light sensing photocell type switch, or may be manually controlled with a manual switch.

Like the first embodiment, the housing 92 of the second embodiment may be substantially weatherproof. However, the shape of the housing 92 may differ slightly. As shown in FIG. 8, the housing 92 may take the form an inverted cone shape defining a continuous sidewall 94 and a substantially flat top 96. Like the first embodiment, the housing 92 may be supported on an anchor member 98, such as a stake mount or the like, which may be driven into the ground to support the lighting system 90, or may include a bracket or the like for attaching the lighting system 90 to a structure.

Like the first embodiment, the solar energy system may take the form of one or more photovoltaic cells or panels 110, which may be supported on the upper portion of the housing 92. The inverted cone shape of the housing 92 orients the photovoltaic panels 110 upward to help better position the panels 110 to collect solar rays. The panels 110 may be positioned around the housing 92 to absorb solar rays as the sun moves relative to the panels 110. The photovoltaic panels 110 may also be in electrical communication with the energy storage source.

FIG. 9 depicts a variety of styles for any of the lighting systems described above, or otherwise incorporating at least of the features described above for the various embodiments of a lighting system. Various styles of decorative brackets 20, 22, 24, 26 may be connected to the posts, or other portions of the lighting system, to change the aesthetic appearance of the lighting system. For example, some of the decorative brackets 20, 24 may resemble leafs, and other decorative brackets 22, 26 may be formed from an inwardly spiraling curve. The foregoing example is merely illustrative of some styles for the decorative brackets and is not intended to limit the use of other styles or shapes of decorative brackets with the lighting system.

The various components of the lighting system, including, but not limited to, the housings 40, 92, the post, the anchor members 16, 98, the blades 34, the decorative brackets 18, 20, 22, 24, and 26, and so on, may be composed of any suitable material, including, but not limited to, metal, plastic, fiberglass, alloys, carbon composites, or any combination thereof. Further, the various components may be formed from one or more parts. Any parts for each component may be joined together to form the component using any suitable connection method.

The energy storage system for a lighting system may power one or more lighting elements not joined or contained within the housing that contains the energy storage system. For example, one lighting system may contain one or more energy storage systems while other lighting systems may receive power for their respective lighting attachments from these one or more energy storage systems. Yet further, the energy storage systems and/or energy collection systems may or may not be supported by and/or contained within the lighting system. For example, the energy storage systems and/or the energy collection systems may be positioned in a central or other location proximate the one or more lighting systems to provide electrical energy to power the lighting elements associated with these lighting systems.

Although various representative embodiments of this invention have been described above with a certain degree of particularity, those skilled in the art could make numerous alterations to the disclosed embodiments without departing from the spirit or scope of the inventive subject matter set forth in the specification and claims. For example, horizontal or vertical wind turbines employing a variety of blade configurations could be employed in various embodiments. Various embodiments may also employ one or more light sources housed in the lighting system enclosure and/or one or more remote light sources connected to the lighting system via one or more lighting elements.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A lighting system comprising:
a housing;
a rechargeable electrical power source disposed within the housing;
a wind energy system proximate to the housing to collect wind energy and convert the wind energy into electrical energy, the wind energy system electrically coupled to the rechargeable electrical power source, such that at least a portion of the wind energy collected and converted into electrical energy recharges the rechargeable electrical power source; and
at least one lighting element electrically coupled to the rechargeable electrical power source.

2. The lighting system of claim 1, further comprising:
a solar energy system to collect solar energy and convert the solar energy into electrical energy, the solar energy system electrically coupled to the rechargeable electrical power source, such that at least a portion of the solar energy collected and converted into electrical energy recharges the rechargeable electrical power source.

3. The lighting system of claim 1, wherein the wind energy system comprises a wind turbine.

4. The lighting system of claim 3, wherein the wind turbine comprises:
a generator; and
at least one blade operably connected to the generator.

5. The lighting system of claim 3, wherein the wind turbine comprises a vertical axis wind turbine.

6. The lighting system of claim 3, wherein the wind turbine comprises a horizontal axis wind turbine.

7. The lighting system of claim 1, wherein the at least one lighting element comprises at least one light source located on the housing.

8. The system of claim 1, wherein the at least one light source comprises a plurality of light emitting diodes.

9. The lighting system of claim 1, further comprising:
a conductor;
a plug operably coupled to the conductor and configured to mate with a connector located on the housing; and
the at least one lighting element comprises a light source operably connected to the conductor.

10. The lighting system of claim 1, wherein the rechargeable power source comprises a plurality of rechargeable power sources.

11. The lighting system of claim 10, wherein at least one of the plurality of rechargeable power sources is selected from the group consisting of nickel cadmium batteries, nickel metal hydride batteries, lithium-ion batteries, and electrical capacitors.

12. The lighting system of claim 1, further comprising:
a support member operably connected to the housing assembly; and
an anchor member operably connected to the support member.

13. The lighting system of claim 12, wherein the anchor member is selected from the group consisting of a ground spike and a bracket.

14. The lighting system of claim 12, further comprising a decorative bracket operably connected to the support member.

15. The lighting system of claim 1, wherein the wind energy system is operably supported by the housing.

16. A lighting system comprising:
means for collecting wind energy;
means for converting wind energy into electrical energy operably associated with the wind energy collecting means;
means for storing electrical energy operably coupled to the wind energy converting means;
means for adjusting a height of the lighting system operably associated with the electrical energy storing means; and
a lighting element operably connected to the electrical energy storing means; and
wherein at least a portion of the electrical energy converted by the wind energy converting means recharges the electrical energy storing means.

17. The lighting system of claim 16, further comprising:
means for converting solar energy into electrical energy operably coupled to the electrical energy storing means; and
wherein at least a portion of the electrical energy converted by the solar energy collecting means recharges the electrical energy storing means.

18. The lighting system of claim 16, wherein the means for collecting wind energy comprises a blade.

19. The lighting system of claim 16, wherein the means for converting wind energy to electrical energy comprises a generator.

20. The lighting system of claim 16, wherein the means for storing electrical energy comprises a rechargeable battery.
